(19) United States
(12) Patent Application Publication
(10) Pub. No.: US 2007/0175708 A1
(43) Pub. Date: Aug. 2, 2007

(54) Novel motor vehicle wheel which is made, for example, from light alloy, and production method thereof

(76) Inventors: Boris Rabussier, Pons (FR); Philippe Meyer, Ronquerolles (FR); Thierry Callais, Breuil Le Vert (FR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/557,545

(22) PCT Filed: May 21, 2004
(86) PCT No.: PCT/FR04/01264

§ 371 Date: Aug. 28, 2006

(30) Foreign Application Priority Data
May 21, 2003 (FR) 03/06090

(51) Int. Cl. B60T 1/06

(52) U.S. Cl. 188/18 A

(57) ABSTRACT

The wheel of the invention is remarkable in that it comprises: a one-piece main portion forming a front face (FA) and a substantial portion of a rim (CJ), and including first arrangements (CI, API, HI) for a first tire seat at the opposite from the front face; and an annular add-on part (S) fitted to the main portion in continuous and airtight manner and comprising at least a portion of second arrangements (HE, APE) for a second tire seat on the side of the front face. In this way, the main portion can be made thinner and lighter in weight (AM) in the vicinity of the second arrangements. The invention is applicable to light alloy wheels for motor vehicles.

The present invention relates in general to motor vehicle wheels made by casting a light alloy such as an aluminum-based alloy.

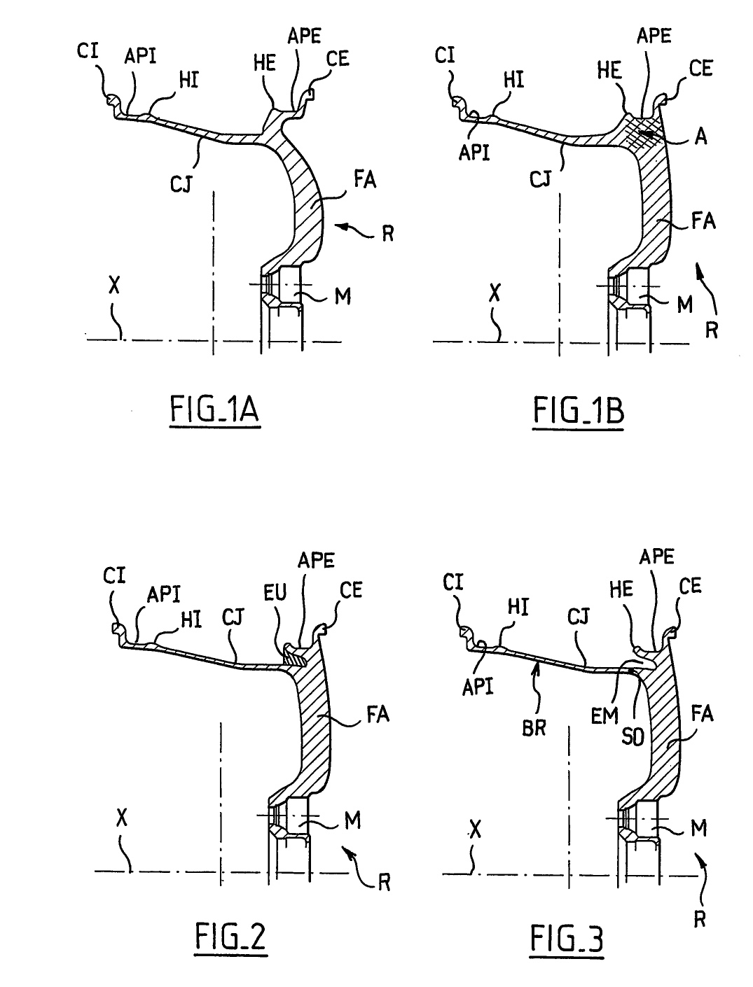

Thus, FIG. 1A of the accompanying drawings is a half-section showing a conventional cast light-alloy wheel R (where X is the axis of rotation of the wheel), comprising a front face FA provided in its center with a hub M and with fastener holes, a peripheral portion in the form of a drop-center rim CJ, an in-board flange CI and an anti-roll-off safety hump HI defining between them an in-board seat API for the tire, and on the opposite side (front face side) an out-board flange CE and an out-board safety hump HE defining between them an out-board seat APE for the tire.

Nowadays there is a trend to make such wheels with a so-called “full face” style, where such wheels are characterized by a type front face FA that is offset little from the out-board flange CE, or that is even practically tangential thereto. FIG. 1B is a half-section through such a “full face” wheel. This figure shows a relatively massive zone A that presents two significant drawbacks: not only does it make the wheel heavier, but also, when the wheel is made by a conventional low pressure casting method with metal being injected from the center of the wheel, substantially on the axis X, it makes solidification more difficult, with a tendency to create microshrinkage in this massive zone A.

Numerous attempts have been made to try to overcome those drawbacks.

Firstly, it is possible to machine pockets EU under the out-board tire seat APE, as shown in FIG. 2 of the drawings. Nevertheless, because of the difficult access, the saving in weight made available by such pockets is limited; furthermore, the wheel continues to be cast in conventional manner, so that this approach does not solve the above-mentioned problem of solidification.

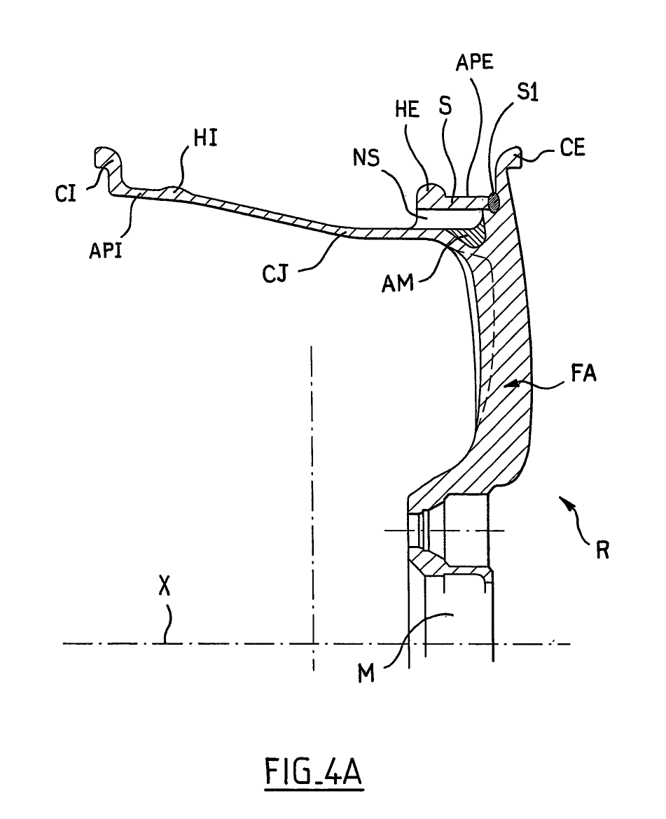

It is also possible to make a wheel in two portions, e.g. as described in document FR-A-2 826 609 in the name of the Applicant, and as shown in FIG. 3.

In this figure, there can be seen a pocket EM that can be made during the casting operation itself, and that can-be discontinuous or continuous in the circumferential direction, except where a valve hole passes therethrough, at which point it must be uninterrupted.

In addition, because in that solution the front face FA is cast separately, the operations of casting and of ensuring high quality are made easier, particularly by omitting masses in the vicinity of the pocket EM, thus making it possible, when the wheel is cast at low pressure from a central feed, to direct solidification effectively towards the center.

Nevertheless, that solution presents certain limitations:

the add-on rim BR is generally made of wrought alloy, which is more expensive than casting alloys, and requires complex transformation operations;

the air-tightness of the wheel and its fatigue behavior depend to a great extent on the quality of the weld SO between the front face and the rim, and welding with aluminum alloys can sometimes be difficult to perform well; and finally

the very concept of that wheel using welding to associate a wrought piece with a front face that is machined separately can lead to a risk of out-of-round radial run-out and unbalance that can be difficult to overcome industrially, particularly in comparison with a one-piece cast wheel, which is machined practically in full apart from its front face (and possibly also machined on its front face, for reasons of appearance).

Finally, document EP 1 112 867 A discloses a lightened wheel having a one-piece main portion forming a front face and a substantial fraction of a rim, and including first arrangements for a first tire seat on the opposite from the front face, and an annular part screwed onto the main portion and including at least a portion of second arrangements for a second tire seat beside the front face.

That known solution nevertheless presents the drawback of not providing satisfactory airtightness for the inside cavity formed by the tire and the rim.

More precisely, the Applicant has found that in rough driving situations or when turning too fast, the tire bead beside the front face is liable to slide laterally inwards towards the retaining hump. Under such circumstances, air can escape to the outside by passing under the add-on annular part, leading to the tire deflating quickly and dangerously.

The present invention seeks to mitigate those drawbacks of the prior art and for this purpose it proposes a motor vehicle wheel characterized in that it comprises in combination:

a one-piece main portion forming a front face and a substantial portion of a rim, and including first arrangements for a first tire seat at the opposite from the front face; and

an annular add-on part fitted to the main portion in continuous and airtight manner and comprising at least a portion of second arrangements for a second tire seat on the side of the front face.

Certain preferred but non-limiting features of this wheel are as follows:

the second arrangements for a second tire seat comprise a rim flange formed on the main portion and an anti-roll-off hump formed on the add-on part;

a seat zone for the tire, adjacent to the rim flange of the second arrangements, is formed on the main portion of the wheel;

a seat zone for the tire, adjacent to the rim flange of the second arrangements, is formed on the add-on part;

a seat zone for the tire, adjacent to the rim flange of the second arrangements, is formed both on the main portion of the wheel and on the add-on part;

a cavity is formed internally at the level of the add-on part;

the cavity is formed between the main portion and the add-on part;

the cavity is formed within the add-on part;

the add-on part is made as a single piece;

the add-on part is made up of a plurality of pieces fastened together;

the add-on part is made of a material selected from the group comprising: metals and their alloys; synthetic materials; and composite materials;

the wheel includes localized support portions for the add-on part;

the support portions are made integrally with the add-on part;

the wheel includes a continuous annular support portion for the add-on part;

the annular support portion is essentially molded with the main portion of the wheel;

the continuous annular support portion extends generally radially outwards, being offset axially from a front face rim flange belonging to the main portion of the wheel (preferably substantially under the safety hump); and

in a circumferential direction of the wheel, the add-on part is interrupted at a protrusion for a valve hole.

In a second aspect, the invention provides a method of manufacturing a motor vehicle wheel, characterized in that it comprises the following steps:

a) forming as a single piece a main portion that forms a front face and a substantial fraction of a wheel rim, and including first arrangements for a first tire seat; and

b) fitting and securing in continuous and airtight manner on the main portion an annular part including at least a portion of second arrangements for a second tire seat,

in such a manner that the main portion can be made thinner and lighter in weight in the region of the second arrangements.

Certain preferred features of this method are as follows:

step a) is implemented by light-alloy casting, followed by machining certain regions of the casting;

step b) is preceded by forming the add-on part by curving it;

the annular part is made of metal and is secured to the main portion by welding;

the step of welding the annular part is followed by machining at least certain portions thereof;

the annular part is obtained by the following steps:
casting the annular part together with the main portion of the wheel in a single mold cavity; and
separating the annular part from the main portion after they have been extracted from the mold;

the mold cavity defines a narrow cutting zone between a main region defining the main portion of the wheel and a region defining the annular part;

the annular part is made of organic or composite material and is secured to the main portion by adhesive; and

the annular part is formed into a closed loop by welding together its ends.

Other aspects, objects, and advantages of the present invention will appear better on reading the following description of preferred embodiments thereof, given by way of non-limiting example and made with reference to the accompanying drawings, in which:

FIGS. 1A, 1B, 2, and 3 are radial half-section views of various prior art wheels made completely or partly by casting;

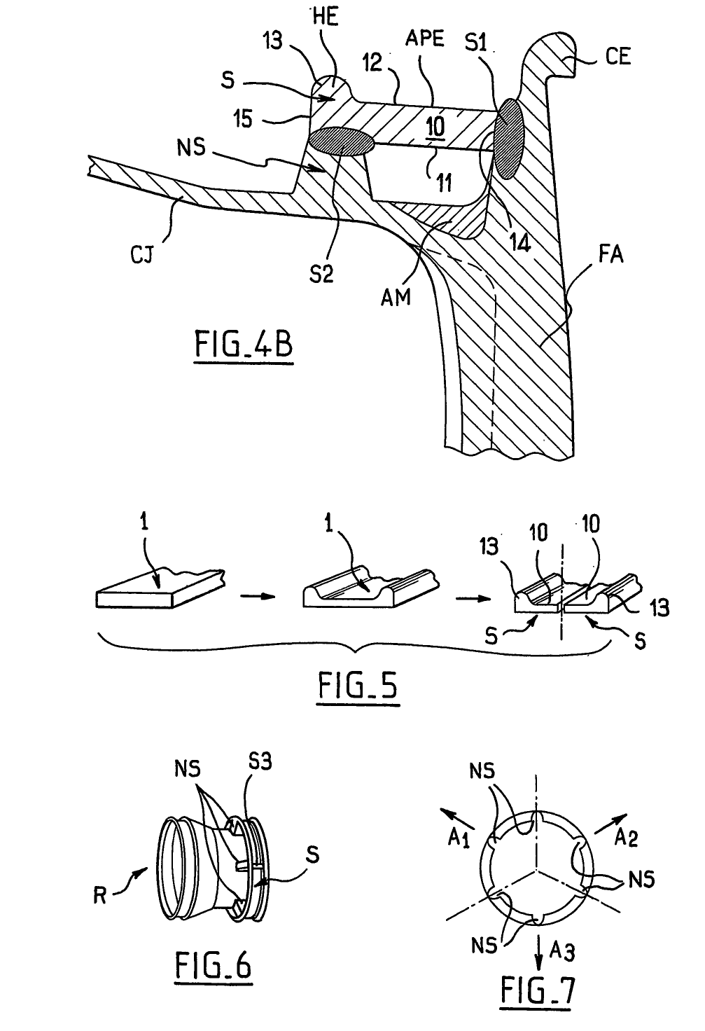

FIG. 4A is a radial half-section view of a wheel according to a first embodiment;

FIG. 4B is a view on a larger scale showing a detail of the FIG. 4A wheel, in a variant embodiment;

FIG. 5 shows an example of three steps for forming an add-on part belonging to the wheel of FIGS. 4A and 4B;

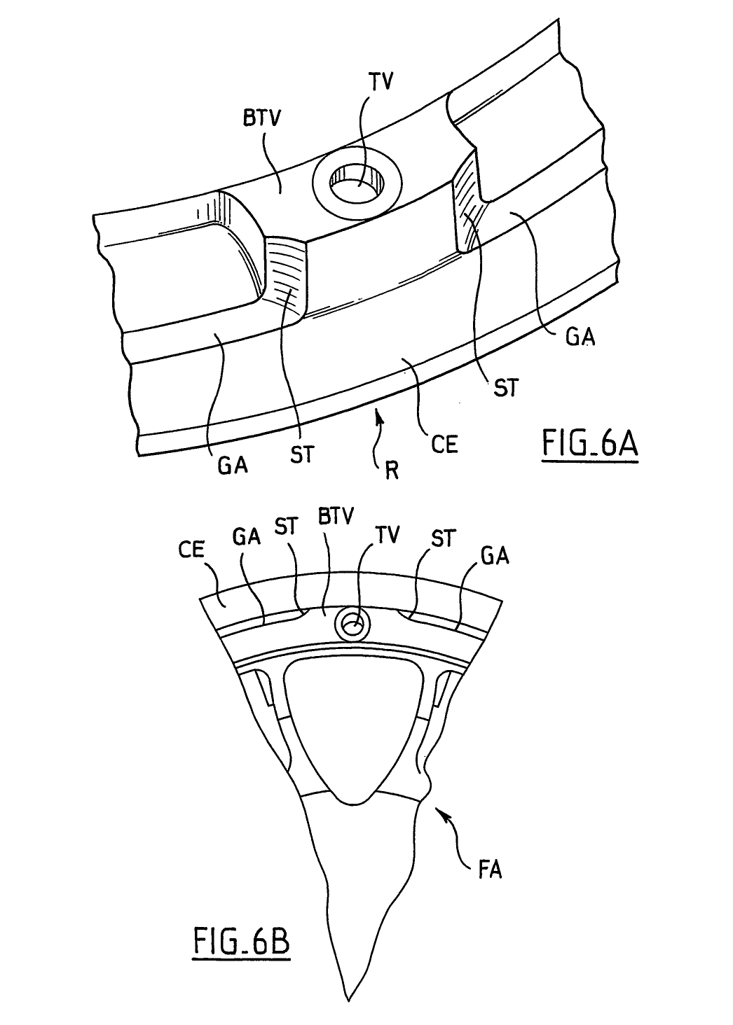

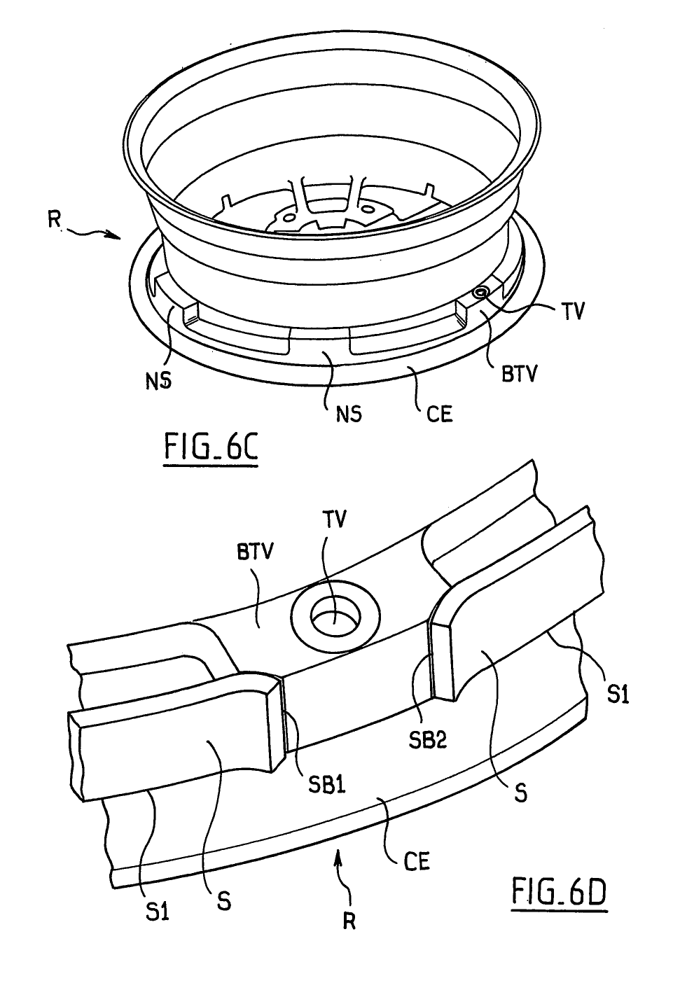

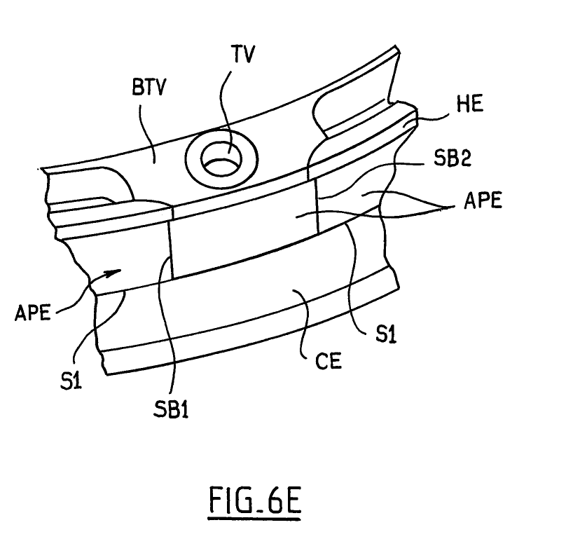

FIG. 6 is a perspective view of the wheel, showing a variant thereof;

FIGS. 6A to 6E show a variant of the invention with a particular configuration for the valve hole, FIG. 6A being a detail perspective view of the wheel before the add-on part is mounted, FIG. 6B being a fragmentary plan view from the side opposite to the front face, with the drop-center rim omitted, FIG. 6C being an overall perspective view with seat elements of an add-on part, and FIG. 6E being a detail view in perspective after the add-on part has been put into place and final machining has been performed;

FIG. 7 is a cross-section view showing the same variant embodiment as FIG. 6, for showing more clearly a particular embodiment of the seat arrangements, but without showing the valve hole protrusion;

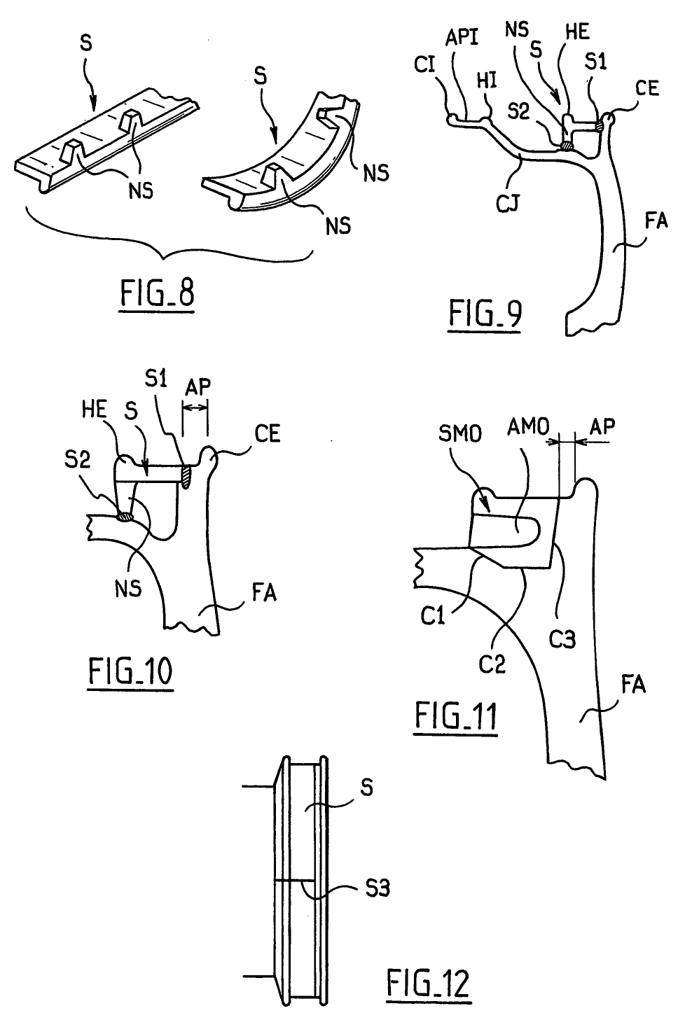

FIG. 8 is a perspective view showing the shaping of an add-on part in yet another variant embodiment;

FIG. 9 is a partial radial section view of another variant of the invention;

FIG. 10 is a view on a larger scale of a modification made to the FIG. 9 variant;

FIGS. 11 and 12 are respectively a partial radial section view and a partial elevation view of another embodiment of an add-on part on a wheel in accordance with the invention; and

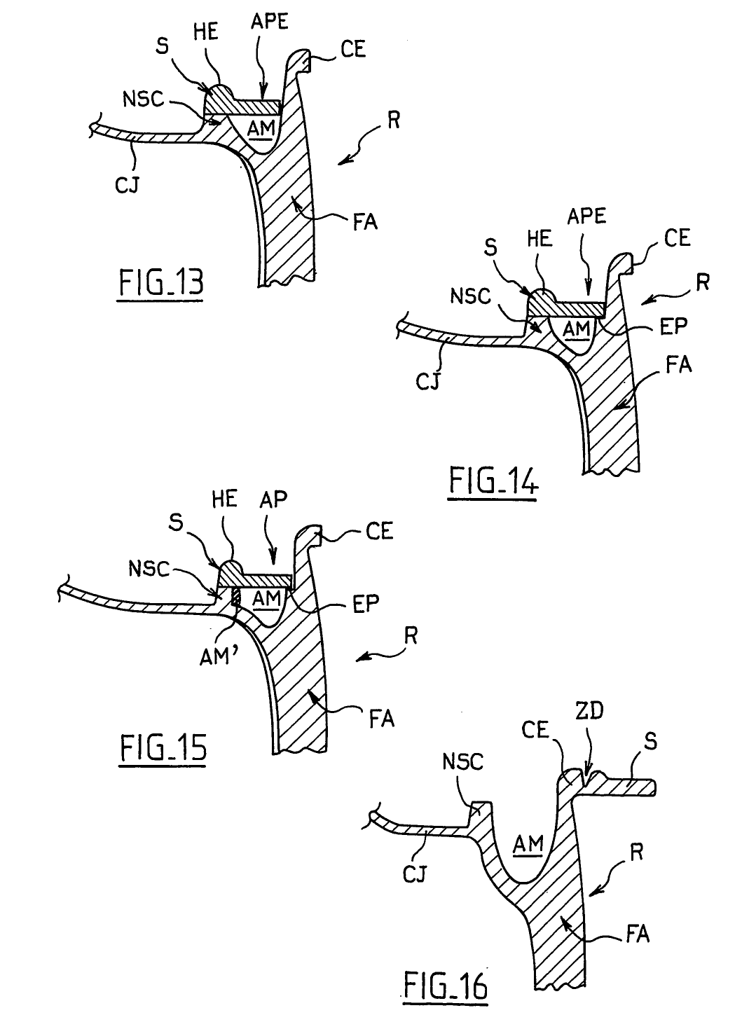

FIGS. 13 to 16 are diagrams showing different variant embodiments of the invention.

As a preliminary point, it should be observed that from one figure to another elements or portions that are identical or similar are designated wherever possible by the same reference signs.

With reference initially to FIG. 4A, there is shown a wheel R having an annular add-on part S fitted thereto by welding in continuous and airtight manner, the part S forming an out-board seat for the tire, which part includes the out-board safety hump HE and all or part of the out-board tire seat APE.

This part S is added to a cast aluminum rim that comprises the front face FA terminating peripherally by the out-board flange CE, the hub M, the drop-center rim CJ, the in-board hump HI, the in-board tire seat API, and the in-board flange CI.

In the embodiment of FIG. 4A, the seat S is an add-on part welded close to the flange CE via a continuous and airtight weld Si beneath the seating zone APE for the installed and inflated tire.

At this point, it should be observed that the invention makes it possible to further reduce the weight beneath the seat as obtained by casting, e.g. by extension to the shaded zone AM, and also to arrange lightenings between the seat S and the region of the wheel underlying the seat.

Whatever the type of welding used, it is preferable to perform the machining after welding. The welding must be of sufficiently high quality not only to ensure that it is continuous, but also to ensure that there is no leakage from the space inside the tire under extreme driving conditions where the tire bead can move over the seat zone APE (to the left in FIG. 4A).

Advantageously, support ribs NS are provided, being disposed circumferentially and preferably regularly distributed, so as to make it easier to fit the tire (in particular by preventing it from jamming between the seat S and the hollow portion of the underlying rim), and to strengthen the support provided by the seat S.

In FIG. 4A, the ribs NS extend over the entire width of the seat S parallel to the axis X, and the seat S merely presses against the ribs.

In the variant of FIG. 4B, stiffening can be further improved by a series of welds S2 at the level of the bearing points between the seat S and the ribs NS. Such welds can be implemented either in the plane or else directly through the part S when its material and thickness make that possible. In addition, as also shown in FIG. 4B, the ribs NS can be cut away so as to extend only in the vicinity of the region of the seat S that is remote from the weld S1.

As shown in FIG. 4B, the seat S presents a cross-section in the form of a generally flat body 10 with an inside face 11, an outside face 12 constituting all or part of the out-board tire support seat APE, an in-board face 15 over which the out-board hump 13 (HE) is formed, and an out-board face 14 where the weld S1 is made. It should be observed at this point that depending on the position of said weld S1 along the axis X, the inflated tire in a normal running position situated in contact with the flange CE can bear against both the main portion of the wheel and the add-on part S, i.e. over the weld S1, or solely against the main portion, or indeed solely against the add-on part S.

The seat S can be made in various ways.

As shown in FIG. 5, it can be obtained in particular from a strip 1 of aluminum alloy (e.g. of Al/Mg alloy in the standard 5000 series), that is rolled and then split to form two parts S with their respective humps 13.

Thereafter, the part is curved prior to being mounted on the support ribs NS and against the front face FA that is machined to receive it, and then welded together where its ends meet at S3, as shown in FIG. 6.

In a variant, it is possible for the seat S to be made, for example, from a section member, a molding, or an extrusion. It is also possible to use sheet metal of suitable width and thickness, but without any particular shape in relief, and then to give it the desired shape in relief by machining after it has been welded to the remainder of the wheel.

When constraints associated with the style and design of the wheel, and in particular those applicable to a standard wheel profile as issued by an organization such as the European Tire and Rim Technical Organization (ETRTO), do not leave enough room to provide a valve hole protrusion with sufficient cast material between the valve hole and the support for the add-on part S, it is necessary for said add-on part to be interrupted on either side of the valve hole protrusion and to provide another assembly technique.

FIGS. 6A to 6E of the accompanying drawings are various views showing such an implementation of the invention.

The steps in manufacturing this wheel are as follows: after the wheel has been cast and turned, a groove GA is formed by milling, as shown in FIGS. 6A and 6B in particular. This groove is interrupted at a valve hole protrusion BTV housing a valve hole TV, leaving two curved transition surfaces ST corresponding to the radius of the milling cutter used.

FIG. 6C shows the wheel as obtained in this way (before the seat S has been fitted thereto), and also shows the support ribs NS obtained by casting.

The add-on part S is then put into the groove GA and welded, firstly by means of the peripheral weld S1 between the part S and the front face, and secondly by end welds SB1 and SB2 (see FIGS. 6B and 6D) at the ends of the part S, at the level of the transition surfaces ST of the groove GA, where the part S is curved so as to match these surfaces. As in FIG. 4B, it is also possible in this configuration to make a weld S2 between the seat S and each of the support ribs NS. In FIG. 6D, it can be seen that the thickness of the welds is not shown, in order to simplify the drawing.

Thereafter, finishing machining is performed to obtain a surface that is smooth and continuous, as shown in FIG. 6E (with the welds SB1 and SB2 being represented in this figure merely by transverse lines, given their very small real thickness), extending between the out-board hump HE on one hand and the out-board seat APE together with the out-board flange CE on the other hand.

This variant thus makes it possible to use an add-on part S in accordance with the invention even when the protrusion for the valve hole BTV is of a shape such that it prevents the add-on part S from going round the outside thereof.

The ribs NS are preferably made by the cheeks of the mold used for casting, e.g. as shown in FIG. 7 for a mold having three cheeks in plan view. This figure also shows axes A1, A2, and A3 defining the three unmolding axes for the mold cheeks, in conventional manner.

In a variant, it is also possible to make the ribs NS integrally with the seat S. Thus, as shown in FIG. 8, the seat is manufactured, for example, by a pressurized casting method, thus providing a plane seat blank that is subsequently curved and assembled on the wheel prior to being welded thereto.

The resulting assembly is shown in FIG. 9.

This solution presents the advantage of making the ribs NS with a single tooling element, and thus of making the ribs in a manner that is geometrically reproducible and more favorable for mastering unbalance than when the ribs are made by mold cheeks (in particular when the ribs are formed at a junction between two cheeks).

A variant of these solutions is shown in FIG. 10. In this variant, care is taken to perform welding away from the zone AP that acts as a seat APE when the tire is in place and inflated, thus making mastery of flush welding less critical.

The same options as those described above with reference to FIG. 4 can be applied to the variant of FIG. 10.

The technology used for welding aluminum is preferably electron bombardment, however it is also possible to use tungsten inert gas (TIG), metal inert gas (MIG), or laser technologies, alone or in combination. In certain circumstances, with this assembly configuration, it is possible to envisage omitting a full machining pass on the add-on part S after welding.

In another variant embodiment, described with reference to FIGS. 11 and 12, the add-on seat is made in the form of a part SMO made of organic material, e.g. by molding fiberglass-filled polyamide PA 66, which part is then mounted in a cavity shaped in complementary manner around the aluminum rim and is assembled by heat-sealing. It should be observed that this part SMO preferably presents a generally U-shaped section with an open cavity directed towards the inside of the wheel separating a radially outer portion forming the hump HE and possibly also all or part of the tire seat, and an inner portion pressing against the cavity formed for this purpose in the faces Cl and C2, with the base of the U-shape pressing laterally against the face C3.

Ends of the organic material strip SMO can be welded thereto S3 (FIG. 12) either once only, or else in register with each molding cheek join in the wheel so as to make it easier to press each segment of the part SMO down into its cavity. The cavity is preferably obtained directly by casting by using the mold cheeks that serve to make the main portion of the wheel, which cheeks correspond to the surfaces Cl and C2 of FIG. 11.

The organic material of the part SMO is bonded to the main portion in airtight manner so as to ensure that air does not leak out under extreme driving conditions where the tire can be caused to move on its seat APE. The tire seat region (AP in FIG. 11) in the normal position can be either on the main portion of the wheel made of aluminum, or on the part SMO, or astride both of them. In any event, the part SMO is preferably bonded to the main part made of aluminum via the faces Cl, C2, and C3 of the part SMO so as to obtain the best possible sealing.

There follows a description with reference to FIGS. 13 to 16 of different variant embodiments of the invention, more particularly applicable when the add-on part S is a curved strip of metal.

In the variant of FIG. 13, radial support for the add-on part S is provided during casting of the main portion of the wheel by providing a single continuous circumferential support rib NSC. It should be observed at this point that making such a rib does not disturb design of the mold or the molding and unmolding operations to any great extent. A weight reducing cavity AM is formed between the rib NSC and the out-board flange zone CE.

The part S is welded firstly to the rib NSC and/or secondly to the face of the main portion that is set back from the out-board flange CE.

At least one of these two welds is made in airtight manner so as to avoid losing pressure under extreme driving conditions when the bead of the tire moves laterally. For example, the weld against the out-board flange zone CE is welded continuously while the weld to the rib NSC is performed discontinuously, e.g. by spot welding, possibly through the hump HE if it is not too thick.

Concerning the configuration of the valve hole, various approaches can be envisaged, depending on where the welding is made to be continuous and airtight. In the example described in the preceding paragraph, the valve may be secured in the wall of the front face of the wheel in the vicinity of the flange CE, with a hole being provided to allow air to flow through the continuous rib NSC.

FIG. 14 shows this variant being implemented with the positioning of the seat S being facilitated by a shoulder EP that is molded in the surface of the main portion that is set back from the out-board flange CE.

FIG. 15 shows this variant being implemented with an additional reduction in weight of the main portion of the wheel being achieved by removing extra material AM' by machining (preferably by turning) from the recess AM that extends between the circumferential support rib NSC and the wall adjacent to the front face, so as to lighten the wheel even further.

In the configurations of FIGS. 13 to 15, it can be seen that the final shape of the wheel of the invention is identical or in any event very similar to the shape of a conventional wheel beside the tire cavity in the zones CE, APE, HE, S, NSC, and CJ, which means that a tire can be mounted under the same conditions as for a conventional one-piece wheel.

Finally, FIG. 16 shows a particular embodiment of the part S where it is cast together with the wheel. More precisely, the mold cavity for forming the wheel is associated with a cavity for forming the part S in the form of an annular strip of diameter close to the diameter it is to have once it is welded in position as described above. This cavity for the part S is located adjacent to the zone of the out-board flange CE.

Advantageously, the strip S is machined to prepare it for welding prior to being separated from the remainder of the wheel. A narrow cutting zone ZD can be defined by the mold cavity so as to make it easier to separate the wheel itself from the part S.

After being cut away, the circumferential length of the strip can be adjusted, if necessary, assuming it needs to have a smaller diameter. Thereafter it is placed on the supports as described above and welded in position in continuous and airtight manner.

This solution makes it possible to reduce the cost of obtaining the add-on part S, and thus the overall cost price of the wheel. In addition, using identical material for the wheel itself and for the add-on part makes it possible to simplify welding problems.

It should be observed at this point that this technique for obtaining the add-on part S during the operation of casting the wheel can be implemented with any of the support shapes described above.

Furthermore, for molding purposes, the part S can be located relative to the main portion of the wheel at locations other than in the vicinity of the out-board flange CE (for example in the vicinity of the in-board flange CI).

In all of the examples above, it should be observed that the one-piece main portion of the wheel (hub, front face, drop-center rim, and arrangements on the in-board side CI, APE, and HI) is made by casting a single aluminum part and by machining (apart from the raw surfaces of the front face, the recesses AM under the seat part S, and the adjacent arrangements such as the ribs NS, and the pockets in the rear face), thus ensuring excellent control over dimensions and thus making it possible to minimize unbalance and radial run-out.

It should also be observed that, while the wheel is normal operation, no major mechanical force passes through the welds between the main portion of the wheel and the add-on part, thus making control over welding less critical than it is for making a wheel as shown in FIG. 3.

In addition, the pockets made in the main portion of the wheel are obtained directly during casting, which makes the wheel easier to make and in particular makes it possible to avoid having zones that are too massive and subject to microshrinkage (in zone A of FIG. 1B) when the wheel is made as a one-piece casting.

The wheel of the invention can be used with materials that are inexpensive, namely:

light alloys for casting;

organic materials; and

where appropriate, very small quantities of wrought materials.

In general, the invention makes it possible to maximize weight reduction, either by machining in zone A of FIG. 1B, or preferably directly while casting the wheel, thus making it easier to feed the wheel while solidification is taking place and also making it possible to reduce the thickness of the arms.

In a variant, it is quite possible to make the main portion of the wheel by other technologies such as forging or casting-forging, possibly together with heat treatment prior to fitting on the seat S.

As described above, the seat S can be made as a single piece or as a plurality of pieces, using castings, sheets, or section members that are preferably initially rectilinear and that are curved prior to assembly. The seat material can be metal, a synthetic material, or a composite material.

Naturally, numerous variants and modifications can be made to the invention by the person skilled in the art.

1. A motor vehicle wheel, characterized in that it comprises in combination:
a one-piece main portion forming a front face (FA) and a substantial portion of a rim (CJ), and including first arrangements (CI, API, HI) for a first tire seat at the opposite from the front face; and
an annular add-on part (S; SMO) fitted to the main portion in continuous and airtight manner and comprising at least a portion of second arrangements (HE; HE, APE) for a second tire seat on the side of the front face.

2. A wheel according to claim 1, characterized in that the second arrangements for a second tire seat comprise a rim flange (CE) formed on the main portion and an anti-roll-off hump (HE) formed on the add-on part (S; SMO).

3. A wheel according to claim 2, characterized in that a seat zone (APE) for the tire in a normal running position, adjacent to the rim flange (CE) of the second arrangements, is formed on the main portion of the wheel.

4. A wheel according to claim 2, characterized in that a seat zone (APE) for the tire in the normal running position, adjacent to the rim flange (CE) of the second arrangements, is formed on the add-on part (S).

5. A wheel according to claim 3, characterized in that a seat zone (APE) for the tire in the normal running position, adjacent to the rim flange (CE) of the second arrangements, is formed both on the main portion of the wheel and on the add-on part.

6. A wheel according to any one of claims 1 to 5, characterized in that a cavity (AM; AMO) is formed internally at the level of the add-on part (S; SMO).

7. A wheel according to claim 6, characterized in that the cavity (AM) is formed between the main portion and the add-on part (S).

8. A wheel according to claim 6, characterized in that the cavity (AMO) is formed within the add-on part (SMO).

9. A wheel according to any one of claims 1 to 8, characterized in that the add-on part (S; SMO) is made as a single piece.

10. A wheel according to any one of claims 1 to 8, characterized in that the add-on part (S; SMO) is made up of a plurality of pieces fastened together.

11. A wheel according to any one of claims 1 to 10, characterized in that the add-on part (S; SMO) is made of a material selected from the group comprising: metals and their alloys; synthetic materials; and composite materials.

12. A wheel according to any one of claims 1 to 11, characterized in that it includes localized support portions (NS) for the add-on part (S).

13. A wheel according to claim 12, characterized in that the support portions (NS) are made integrally with the add-on part (S).

14. A wheel according to any one of claims 1 to 11, characterized in that it includes a continuous annular support portion for the add-on part.

15. A wheel according to claim 14, characterized in that the annular support portion is essentially molded integrally with the main portion of the wheel.

16. A wheel according to claim 15, characterized in that the continuous annular support portion extends generally radially outwards, being offset axially from a front face rim flange belonging to the main portion of the wheel.

17. A wheel according to any one of claims 1 to 16, characterized in that, in a circumferential direction of the wheel, the add-on part (S) is interrupted at a protrusion for a valve hole (BTV).

18. A method of manufacturing a motor vehicle wheel, the method being characterized in that it comprises the following steps:
a) forming as a single piece a main portion that forms a front face (FA) and a substantial fraction of a wheel rim (CJ), and including first arrangements (CI, API, HI) for a first tire seat; and
b) fitting and securing in continuous and airtight manner on the main portion an annular add-on part (S; SMO) including at least a portion of second arrangements (HE; HE, APE) for a second tire set.

19. A method according to claim 18, characterized in that step a) is implemented by light alloy casting, followed by machining certain regions of the casting.

20. A method according to claim 18 or claim 19, characterized in that step b) is preceded by forming the add-on part by curving it.

21. A method according to any one of claims 18 to 20, characterized in that the annular part is made of metal and is secured to the main portion by welding.

22. A method according to any one of claims 18 to 21, characterized in that the step of welding the annular part is followed by machining at least certain portions thereof.

23. A method according to claim 21, characterized in that the annular part is obtained by the following steps:
casting the annular part together with the main portion of the wheel in a single mold cavity; and
separating the annular part from the main portion after they have been extracted from the mold.

24. A method according to claim 23, characterized in that the mold cavity defines a narrow cutting zone between a main region defining the main portion of the wheel and a region defining the annular part.

25. A method according to any one of claims 18 to 20, characterized in that the annular part is made of organic or composite material and is secured to the main portion by adhesive.

26. A method according to claim 25, characterized in that the annular part is formed into a closed loop by welding together its ends.
